(19) United States
(12) Patent Application Publication
(10) Pub. No.: US 2013/0268197 A1
(43) Pub. Date: Oct. 10, 2013

(54) WEATHER STATION HAVING A GROUND UNIT WITH A DATA COLLECTION AND TRANSMISSION DEVICE AND A RECEIVING UNIT FOR RECIVING THE DATA

(71) Applicant: Ricardo Ferreira do Amaral, Sao Paulo (BR)

(72) Inventor: Ricardo Ferreira do Amaral, Sao Paulo (BR)

(21) Appl. No.: 13/654,715

(22) Filed: Oct. 18, 2012

(30) Foreign Application Priority Data
Apr. 4, 2012 (BR) 10 2012 007826-0

(51) Int. Cl. G01W 1/02; G06F 17/00

(52) U.S. Cl. CPC G01W 1/02; G06F 17/00
USPC 702/3

(57) ABSTRACT

A weather station including: a ground unit including a data collector unit and a data-receiving unit and a system of transmission of the data from the data collector unit to the data receiving unit. The weather station aims to obtain, weather information, through its data collector unit, which includes transmitting electromagnetic data enabling the transmission of the received data to a remote receiving unit.

### BACKGROUND OF THE INVENTION

The invention provides a weather station including transmitting equipment, a receiving unit and a system of transmission thereof.

The weather station provided herein aims to obtain the weather related information, through the unit data collector, which includes electromagnetic transmitters enabling the transmission of received and collected data to a remote receiving unit.

This system involves the collecting, transmitting and receiving of data to provide, remotely, to an aircraft in transit, essential information to ensure good performance of the pilot in the process of takeoff and landing, and is therefore directed to the segment of general aviation.

Two types of devices are widely known and used in the aviation field and are available commercially, providing to aircraft pilots, relevant weather information to ensure good performance during the standard procedures of takeoff and landing.

The first of them is a windsock having a simple configuration and with an appearance considered rudimental in the present day. The windsock plays an important role in enabling pilots to execute aerial maneuvers, and is of great value in aeronautics.

A common windsock is made from a textile cone tube made from a resin nylon fabric having two open ends where the largest open end is attached to a metal ring assuming a format of a coffee filter.

Despite its constructive simplicity it is often used in airports to indicate the wind direction and the speed of the wind, providing pilots with information, which can be visually obtained, and which is fundamental for them to decide the most appropriate maneuver to that occasion.

A second commercial option in this field is an automated system for updated information that is commonly used in commercial aviation, and is known as ATIS “Automatic Terminal Information Service”. The ATIS is available for busier airports. Whether a facility has the service varies in accordance with the resources of the locale where it is to be installed.

The system can operate fulltime or part-time, and this factor depends on the operational movement and how big the airport is in which the system is installed.

It should be considered that this available commercial system, belonging to the state of the art, requires a significant investment by the airport. Due to its large cost its availability is extremely restricted and locations that have it are very limited.

Due to the disadvantages mentioned above, this system does not meet the needs of all aircraft operators in a general and unrestricted way. Further, it will be difficult for the ATIS to be present in smaller airports due to cost. As a result, it will be directed only to large aircraft arriving and departing from airports containing compatible size and movement.

This ATIS system was developed to provide relevant data to the pilots. This data includes availability of the runway and its conditions, as well as information related to the braking characteristics, possible delays, wind, visibility, cloud cover, ceiling, weather conditions present at the time and in that place.

The system requires the knowledge of experts in this field who operate in this segment, and this system was developed to work through repetitive broadcasting and through linkage of the data.

Thus, it is an object of the present invention to provide a system that automatically captures local information, and transmits the information to the pilot of the aircraft without the need of the interaction of the air traffic controller.

This is certainly an advantageous option, since it will relieve the controllers on the ground of this requirement and allow them to guide and monitor the aircraft which have this radio equipment. A parallel system would also be obliged to transmit all needed information that the ATIS system undertakes to do.

It is known that flight controllers have a large workload to manage for each plane that is under their control, and this process generates tension and stress that could affect the quality of a service that is extremely important for the safety and preservation of the lives of those who use this means of transport.

Based on the foregoing it ca n be concluded that the windsock which belongs to the state of the art is almost completely handmade and it merely monitors the wind intensity and its direction. A windsock is available to all users in a general and unrestricted way, but it has significant disadvantages.

The second available apparatus, ATIS, is too sophisticated and is a fully automated service that provides pilots with a series of data and information that will influence directly and decisively on the quality of the maneuver to be performed by a pilot. However, the ability to obtain such information is restricted to large airports that have made large investments in developing the system and as a result, is not available to all who wish to have such information.

In addition, the apparatus called as windsock, highly known and used in airports, is limited to providing the visual direction, the wind speed, and the wind surface. These are of high importance, but sometimes is not enough information for a good performance for a calm and safe landing or takeoff, since of her conditional factors of extreme importance will be not available to the pilots from this apparatus.

Further, the use of a windsock as an indicator of the wind direction, which is important for pilots in those airports that are not controlled by control towers, is information that is gathered only by visual observation of the windsock by the pilot when the aircraft is approaching the runway.

When the windsock is seen, it is possible to estimate the wind speed and its direction, i.e., the current condition of the surface wind. However, due to the fact that said indicator is located on the ground, and considering that its perception is exclusively visual and sometimes can be damaged by bad weather conditions, and considering that this apparatus does not provide other information that is important as local barometric pressure, temperature and density altitude, the device falls short of being useful to pilots.

On the other hand, despite the availability and functionality of the “Automatic Information Service Terminal (ATIS)” the communication works through the radio waves transmission system, more specifically by broadcasting of the continuous recorded information which is available in only a few select airports in which there is an area where the terminal control is based.

This ATIS system aims to reduce the congestion of communication frequencies, increasing, on the other hand, control efficiency. The system takes place by repeated automatic transmission of routine information about traffic which is pre-recorded and updated from time to time, in so far as representing changes occur.

This information is intended both for aircraft arriving and those departing from a terminal and is provided simultaneously since there is a compatibility between existing equipment in the aircraft and the one constant in this system, since it is only captured through an exclusive frequency that starts in the first hour of the day, information designated as “A” through to “B” and so on according to the updates that are occurring in the system based on the observation site.

Such service known as ATIS provides the pilot with information such as: name of the place and time of observation, direction and wind speed and its variations, visibility and the runway visual range (RVR), weather conditions present, amount and base height clouds (ceiling), barometric pressure, temperature, other significant information, procedures and runways in use.

One of the main disadvantages of this service is its unavailability in most medium and small airports. This is because the system is expensive to implement, and this fact derails its installation in most airports. Moreover, the information from ATIS is to be listened to before contacting the local control unit, in order to reduce the controllers' workload. The sound quality sharpness of the broadcast isn't clear and at the same time there's the aircraft noise.

Based on the foregoing, one concludes that the service was developed to meet the needs of a specific portion of consumers existing in large and medium-size aircrafts, as well as, airports that are able to support such aircrafts, i.e., large and medium size airports.

The consequence of the high cost for obtaining this information service makes it impossible for smaller airports or airfields to purchase the service. They do not have sufficient money to invest in its facility, either in its installation or in the maintenance of equipment as required for functioning of that system.

The technical requirements, as well as those of a financial nature, limit the ability of pilots to obtain essential information to the successful execution of an aerial maneuver.

Besides the problem of high costs involved in implementing this service, other technical disadvantages were detected in this service.

Since this system preferably uses the technology of broadcasting in VHF frequency and/or any other radio frequency for repeated and continuous transmission of remote pre-recorded information that is updated upon the occurrence of any significant change, the information is received only by audio.

A system that is structured only in the audio is likely to be disturbed, and consequently will generate the lack of clarity necessary for a good understanding and comprehension of the information being transmitted.

In order to solve that problem, the ATIS system has been developed using recorded information and giving pilots the opportunity to listen to the messages as often as they need. On the other hand, the ATIS system has as a disadvantage relating to the need to wait to repeat the message from its beginning. This leads to a delay and a waste of time, sometimes to the message not being available at that moment. To sum up, the ATIS system only operates in a few airports where there's a controller to contact when landing. Most airports in the world don't have any way in which to announce the weather information.

### SUMMARY OF THE INVENTION

The present invention aims to provide to aviation operators a new option for obtaining information relevant and necessary to conduct a standard procedure most suitable for takeoff and landing. The information is more accessible, and the capital investment for its manufacture, implementation and maintenance is considerably lower than previously known systems belonging to the current state of the art.

Therefore, one of aim of the present invention is to provide a new tool that will stand at an intermediate range of those already known options present in the current state of the art.

The invention relates to a weather station including a unit arranged to detect information pertaining to climate among which includes: atmospheric pressure based on sea level (QNE or QNH), local air temperature, wind direction, and wind speed. It is also conceivable that other types of data can be sent through the current instrumentation contemplated. The invention further includes a receiving unit that captures the transmitted data and the information transmission system to reach their final destination.

This system provides a process chain to capture, transmit and receive essential data for takeoff and landing procedures at uncontrolled and controlled airports. Another objective of the present invention is to provide those who engage in air navigation important information when a windsock is disabled, or if the service available through ATIS is not available.

The present invention also has the objective of providing a weather station including pickup elements and weather information and elements to receive the information remotely through a data transmission system. The weather station may be installed on any airfield, regardless of their size, and may be used by all aircraft holding a receiver or any other type of radio frequency module that is located onboard and capable of decoding the captured information.

The weather station can be installed independently of pre-existence of other information station previous installed, since it does not represent any threat of interference to them.

The information provided by such a weather station will result in the taking of appropriate actions for the landing or takeoff procedures and ensure they are conducted properly and safely.

Although the technology of broadcasting and data transmission remotely is widely known and studied, there is not until now the availability of a specific cost effective system for aircraft to indicate in clear, precise and concise information about the climatic conditions on the ground from one location or a region.

The inventive weather station enables the information to be available on a display since the recognition of visual information takes place immediately giving the pilot the perfect understanding of the climatic aspects of that locality at the time of the maneuver, and such aspects are fundamental to making altimetry adjustments, routes of approach lanes, in short, for those operations that can be assessed after the advance knowledge of the specific wind data, ground temperature, etc.

Furthermore, the system was developed based upon the potential failure of one to understand an audio transmission that may occur using ATIS, since ATIS systems only give the information via a voice recording, which may not be clear or may be adversely affected by any other external noises to the system.

The current inventive system provides the transmission of data from a meteorological station that has the ability to detect, transmit and receive data remotely.

The weather station that is the object of this invention is made up of a ground unit, which is directed to capture data via the inclusion of a tower data collector that forms part of the ground unit.

The tower data collector includes a plurality of sensors, which are responsible for the detection of the desired information. The tower data collector should be installed on firm ground, specifically at strategic points respecting the terrain peculiarities at each airport. In compliance with the conditions, the tower is able to provide, through its sensors, a correct reading of atmospheric data in real time.

More specifically, the tower data collector that is located on the ground of the air facility is provided with a wind speed sensor, a wind direction sensor, a temperature sensor and an atmospheric pressure sensor.

The tower data collector also has an antenna capable of receiving and transmitting the collected data.

At the other end of this communication there is a receiving data unit that must be installed inside the aircraft, which will henceforth be represented by a radio receiver, which receives the information captured by the ground unit, including: a data processor, an antenna and a display screen exhibiting graphical and numerical images.

In view of the fact that the radio receiver has the sole function to inform the pilot about conditions in the airspace, the radio receiver is strategically installed inside the cockpit in a location for easy visibility.

The meteorological or weather station, through the tower data collector, will collect the following information or other information that is suitable to the system, which will be transmitted to the mentioned radio receiver installed inside the aircraft, in order for the pilot to have access to informational items, quoted below, which are of the extremely important for takeoff and landing procedure to be conducted in a completely predictable way:
Adjust Altimeter (barometric pressure adjusted to sea level—with this data the pilot can set an aircraft's altimeter to read altitude above mean sea level within a certain defined region.
Ground Temperature (this data is essential for the pilot to know the lift conditions close to the ground, especially in fast aircrafts where it is relevant depending on the length of the runway);
Wind direction (allows the pilot to know in advance what direction the wind is on the ground);
Wind speed (allows the pilot to know if is able to land on this site).

The data transmission system obtained by the ground collector unit through the tower data collector includes collecting data from sensors, which are subjected to the processing unit and directed to the electromagnetic radio transmitter, which is received by the receiving data unit represented by the radio receiver, where by means of data processors information is decoded, and displayed on the display screen of the unit, allowing the operator take the acknowledgment of the complete information useful for a safety performance. It is also conceivable that the information may be viewable on a screen already present onboard an aircraft that is modified to receive such data.

The radio receiver of information installed in the aircraft includes a data processor, which through an interface system displays on screen the information captured. The radio receiver does not require calibration settings for its operation, and it is sufficient that it be connected and charged.

The display screen is configured so that the information is available in a clear and organized visual manner in order to allow recognition of data on a screen display that is obtained by the operator.

When receiving of the data, the data is decoded, processed and displayed on the screen of the radio receiver that is installed on the aircraft, and upon the request of the pilot, will be readily be able to be consulted.

### BRIEF DESCRIPTION OF THE DRAWINGS

This invention will be more fully understood from the description given hereunder with reference to the accompanying drawings, not limiting but in the explicative way, in which:

FIG. 1 is a perspective view of the ground collection unit for data capture which is herein also referred to as a tower data collector.

FIG. 2 is a partially cutaway perspective view of the left side of the receiving data unit showing the processor contained therein, according to the present invention.

FIG. 3 is a partially cutaway perspective view of the right side of the receiving data unit showing the radio receiver installed in the apparatus according to the present invention.

FIG. 4 is a diagram illustrating the complete system that involves the process of capturing, transmitting and receiving the informative data in accordance with the present invention.

### DETAILED DESCRIPTION OF THE INVENTION

The purposes of the invention will be fully understood with respect to the illustration described above, which accompanies this application, including the characteristics of the weather station, the parts and components thereof, as well as, the system used for the operation of the meteorological station.

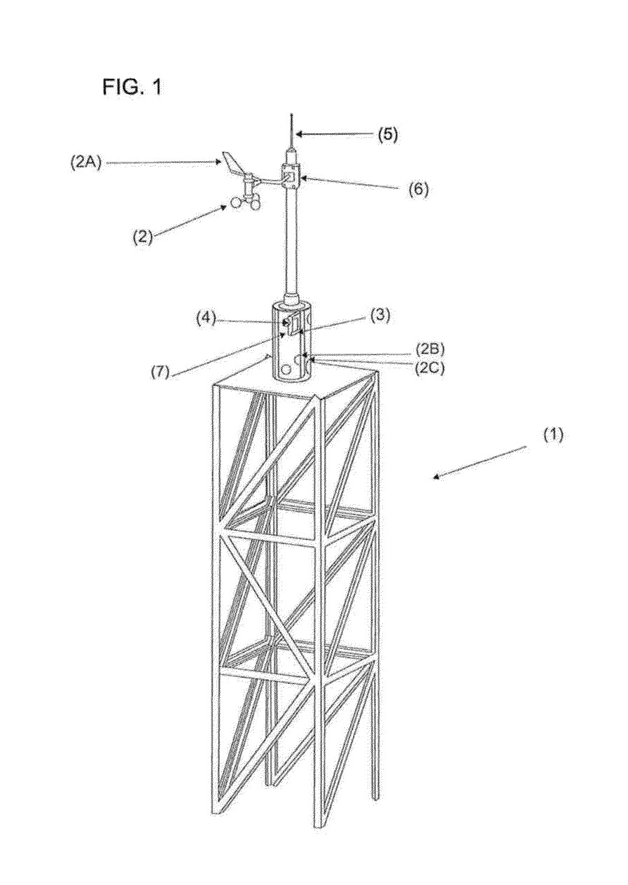

FIG. 1 depicts a ground unit including a tower data collector (1) configured to capture data. The tower data collector (1) also includes a plurality of sensors for capturing information (2, 2A, 2B, and 2C). In particular, the tower data collector (1) includes a wind speed sensor (2), a direction wind sensor (2A), a temperature sensor (2B) and an atmospheric temperature sensor (2C). The sensors are designed to measure the wind speed, wind direction, temperature, and atmospheric pressure, and are adapted for positioning themselves in different locations. The wind speed sensor (2) and direction wind sensor (2A) are located in the upper housing body (6), while the temperature sensor (2B) and the atmospheric pressure sensor (2C) are located in the medium body housing (3).

The tower data collector (1) further includes a data processor (7) and a radio transmitter (4), both located in the medium housing body (3). The tower data collector (1) also includes an antenna (5) responsible for capture and transmission of signals collected collecting data by the tower data collector (1) to the data receiving unit (8).

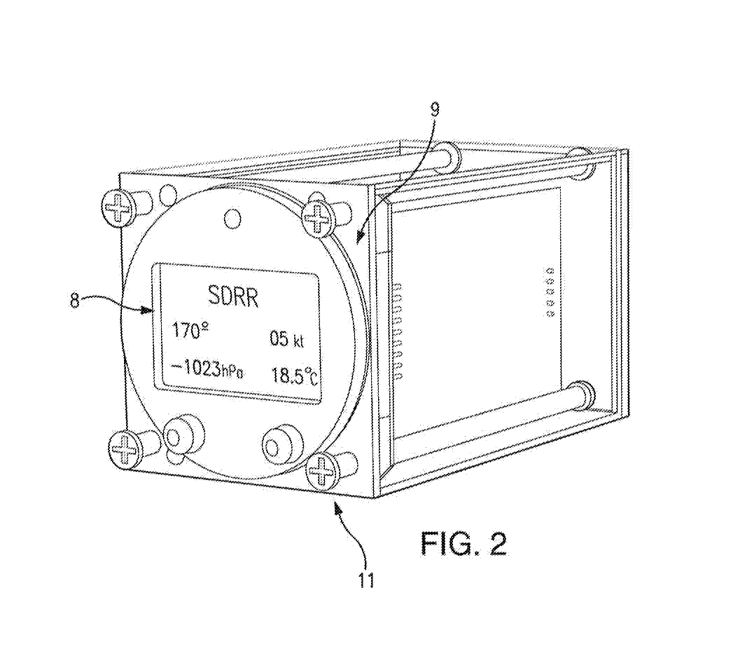

FIG. 2 refers to the data receiving unit (8) which is installed within an aircraft, in a side sectional view, showing its right end in which there is installed a data processor (9), responsible for decoding the information received, and a display screen (11) in operating mode.

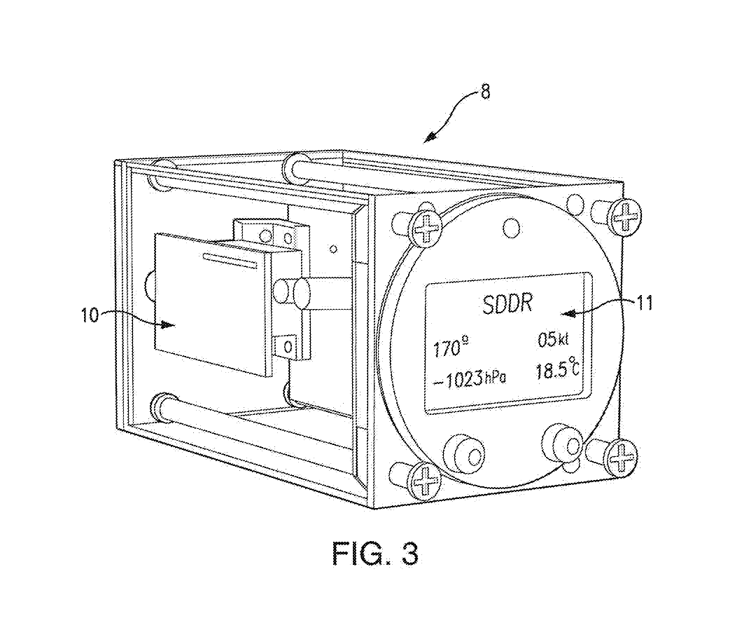

FIG. 3 refers to the data receiving unit (8) in a sectional side view opposite that side shown in FIG. 2, evidencing the radio receiver (10) and data display screen (11) in operating mode.

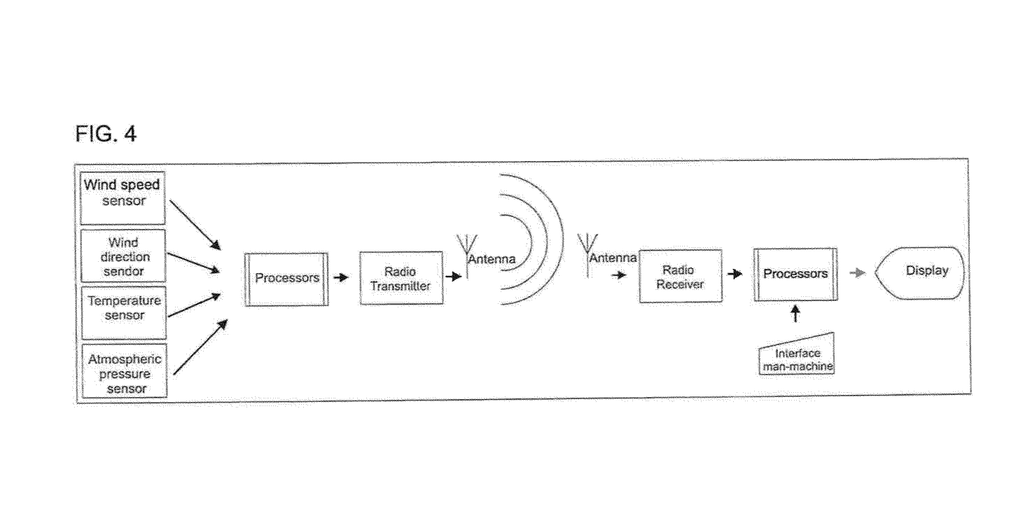

FIG. 4 refers to a system's operating weather station that begins by capturing information obtained by the tower data collector (1) by means of a speed sensor, a wind direction sensor, a temperature and an atmospheric pressure sensor (2, 2A, 2B and 2C). These data are decoded by the data processor (7). After completing the processing of information, the decoded data is sent to the radio transmitter (4) which in turn directs it to the transmitting antenna that transmits the data through the antenna (5) to the data receiving unit (8). The information is then captured by a remote antenna, not shown, and incorporated into the data receiving unit (8). The data is captured by the aircraft remote antenna and received by the data receiving unit (8) that reaches the radio receiver (10) which undergoes the decoding process which occurs in the data processor (9) and which is available on the display screen (11).

Such system only works where there is data transmission compatible with the device, eliminating any possibility of interference that can pose a risk to the pilot and aircraft.

It is an object of this weather station to provide benefits to both users of the equipment as well as the manufacturers of the system, in that such equipment may be produced in large industrial scale at very low cost.

There will be no incompatibility or additional requirement for installation of this equipment in aircraft or in the ground.

Improvements, changes or benefits that do not run from the scope of this request should also be contemplated by the invention.

While the preferred embodiments have been shown and described, it will be understood that there is no intent to limit the invention by such disclosure, but rather, is intended to cover all modifications and alternate constructions falling within the spirit and scope of the invention.

1. A weather station comprising:
a ground unit including a tower data collector, the data tower collector includes a plurality of sensors to capture data from wind speed, wind direction, temperature and atmospheric pressure;
a data processor for decoding the data;
an electromagnetic radio transmitter to transmit the data after decoding; and
a data receiving unit installed in an aircraft;
the data receiving unit comprising an antenna, an electromagnetic radio receiver, a data processor and a display screen.

2. The weather station according to claim 1, wherein the display screen of the data receiving unit displays ground wind speed, ground wind direction, ground temperature and ground atmospheric pressure.
